(19) United States
(12) Patent Application Publication
(10) Pub. No.: US 2019/0130241 A1
(43) Pub. Date: May 2, 2019

(54) Transponder, in Particular a Radio-Frequency Identification (RFID) Transponder, and Method for Operating the Transponder

(71) Applicant: Siemens Aktiengesellschaft, Muenchen (DE)

(72) Inventors: Dominic BERGES, Muenchen (DE); Soenke Christoph Wilhelm APPEL, Ulm (DE); Andreas ZIROFF, Muenchen (DE)

(21) Appl. No.: 16/097,519

(22) PCT Filed: Feb. 27, 2017
(86) PCT No.: PCT/EP2017/054492

§ 371 Date: Oct. 29, 2018

(30) Foreign Application Priority Data
Apr. 29, 2016 (DE) 10 2016 207 424.5

(51) Int. Cl. G06K 19/077; G06K 19/07

(52) U.S. Cl. CPC G06K 19/07773; G06K 19/0723

(57) ABSTRACT

A method and transponder in which at least one first line is formed by at least one first and at least one second antenna configured and operated in the manner of a backscatter, where the antennas are interconnected to one another such that, upon reception of a signal, the antennas scatter the signal back in the manner of a backscatter by a formed emission characteristic.

### CROSS-REFERENCE TO RELATED APPLICATIONS

This is a U.S. national stage of application No. PCT/EP2017/054492 filed Feb. 27, 2017. Priority is claimed on German Application No. DE102016207424.5 filed Apr. 29, 2016, the content of which is incorporated herein by reference in its entirety.

### BACKGROUND OF THE INVENTION

### 1. Field of the Invention

The present invention relates to a transponder, in particular a Radio-Frequency Identification (RFID) transponder, and a method for operating the transponder.

### 2. Description of the Related Art

In the context of Industry 4.0, the identification and localization of people and objects is becoming more and more important, in which case an important aspect is wireless modality.

The so-called Radio Frequency Identification (RFID) systems can be used to substitute information from a tag (transponder) to a reading device (interrogator, reader).

Such a system usually comprises a few reading devices and many tags. Asymmetric complexities are also conceivable, i.e., the interchange of information from the reading device to the tag, or a multi-node scenario (for example, Zigbee technology), the interchange of information between all tags and reading devices which are present.

In addition to interchanging information, the telemetric information is an important part for expanding the performance horizon of the system. An elementary part of telemetry is the localization and determination of the orientation that is intended to be separately highlighted.

In this case, the determination of the orientation is synonymous with the determination of the location and, without restricting generality, is measured in roll, pitch and yaw angles, whereas the localization is synonymous with the determination of the position which, without restricting generality, is measured in height, depth and length or azimuth, elevation and distance.

Systems that can gather and transmit the multiplicity of items of information can be used to implement an extensive portfolio of applications. For example, it is possible to implement monitoring in the logistics and the associated possible applications such as an intelligent warehouse etc. Alternatively, a load on a crane can be localized and its location can be determined in order to then control it in an optimum manner. Many further applications can be implemented using such systems which are not discussed any further here.

With regard to certain performance parameters, such as the communication robustness, the range between the tag and the reading device (attenuation is proportional to the range: attenuation˜r⁻⁴), the power consumption of the tag, the size, the complexity of the circuit of the tag and the associated costs, the system is intended to be available (in a complex environment) with a multiplicity of electromagnetic (EM) effects such as multi-path reflections and shadowing. Multi-path propagation is an effect that greatly reduces performance. The multi-path challenge addresses the effects produced by multi-path propagation. That is, a signal is repeatedly reflected in a space in which measurements are performed and repeatedly arrives at the receiver. The overall signal that is added together from the superimposition of the signals from all paths is superimposed to form an overall data stream that cannot be interpreted.

The range, multi-path propagation, determination of the location and system complexity are identified as key performance indicators, in which case these are directly connected to the signal communication robustness. Furthermore, dynamic response problems occur in the reading device if the distance between the tag and the reading device is reduced to a minimum distance.

Overall systems comprising at least one reading device and at least one transponder are known. The transponder can be localized relative to the reading device and/or makes it possible to interchange data. In order to enable the system for localization with respect to the range, radar reading devices are used. If the angle information is additionally intended to be evaluated, MIMO concepts come into play (a so-called MIMO reading device). In order to capture a space sector that is as large as possible, omnidirectional antenna configurations are used. Directional antenna configurations are also used, which antenna configurations increase the range, for example, and can scan the space regions of interest in the context of improving the resolution. The power limitation in the 24 GHz ISM band, for instance, is 100 mW erip (“equivalent isotropically radiated power”). The communication evaluation is ensured via corresponding baseband processing.

In this case, the tag is based on backscatter (BS) antenna foot point modulation. The method of operation of a conventional backscatter tag is as follows: instead of generating the RF carrier in the tag, the RF carrier generated in the reader is reused, tasked with modulation and reflected in a controlled manner. The radiation is carried out as omnidirectionally as possible in order to receive a signal at the reading device irrespective of the orientation of the tag. This makes it possible to implement power-efficient radio communication with a simple hardware design in which the hardware complexity is moved to the reading device side. The transceiver chain is avoided on the tag side.

In this conventional system, only limited radio communication and localization ranges are possible, depending on the design of the antenna systems and the frequency band, and constitute a restriction for a multiplicity of applications. For instance, long ranges are a prerequisite in logistics in order to identify, localize and track containers with a tag from a base station with a reading device. Furthermore, it is not possible to determine the location of the tagged object using such a system.

WO 2015/013240 A1 discloses a system for avoiding collisions between vehicles and pedestrians, in which a portable radar reflector is configured such that it reflects radar radiation emanating from a vehicle.

### SUMMARY OF THE INVENTION

In view of the foregoing, it is an object of the present invention is to provide a method and transponder that overcome the disadvantages of the prior art.

This and other objects and advantages are achieved in accordance with the invention by a transponder, in particular an RFID transponder, in particular an RFID transponder, and a method for operating the transponder.

In the transponder in accordance with the invention, at least one first line of at least one first and at least one second antenna is formed, where the antennas are each configured and operated in the backscatter manner and are functionally interconnected to one another such that, upon receiving a signal, they scatter the signal back in the backscatter manner via a formed radiation characteristic.

In the context of the invention, configured in the backscatter manner and functionally connected means, in this case, that an antenna and a reflective part, for example, form a backscatter element that implements a backscatter function. In accordance with the invention, further antennas provided are always functionally operated such that they also always implement a backscatter function.

In the method in accordance with the invention for operating a transponder, in particular an RFID transponder, at least one first line of at least one first and at least one second antenna is formed, where the antennas are each configured and operated in the backscatter manner and are functionally interconnected to one another such that, upon receiving a signal, they scatter the signal back in the backscatter manner with the same modulation frequency in the simplest case with a phase offset, in particular a controllable phase offset, with respect to one another.

The increase in the range achieved by the invention is drastically extended by the configuration of the tags in accordance with the invention. In addition, the tag has low hardware complexity, i.e., particularly the hardware complexity is transferred from the radar side to lower hardware complexity on the backscatter side and, in association with this, cost efficiency by virtue of radiation being effected in a focused manner in accordance with the invention and the directivity being increased depending on the specific configuration of the invention, and an increase in the range that is directly proportional to the increase in the focusing is therefore achieved.

In this case, the configuration in accordance with the invention is independent of an antenna configuration of reading devices used. In connection with the operation in the backscatter manner, the use of the focusing brings these advantages both during reception and during transmission.

An important possibility of the invention and its embodiments is lighthouse signal behavior generation by deliberately tuning the backscatter array phase. Owing to the system, signal reflection maxima rotate about the array. The angle of the backscatter array relative to the reader can be determined by finding a maximum. This is possible as a result of the direct relationship between the backscatter phase configuration and the signal reflection maximum.

The focusing in accordance with the invention is enabled via the antenna configuration of the invention and its embodiments because they implement beamforming.

In this case, the tag in accordance with the invention has the flexibility of being constructed in a passive, semi-passive or active manner, depending on the requirements imposed on the tag.

In accordance with the invention, the beamforming and the associated illumination are performed at least in the two-dimensional space. This can be expanded to the three-dimensional space by developing the invention. For the solution in the two-dimensional space, at least two antennas are arranged on a line, where the same modulation frequency is applied to all antennas. In accordance with the invention, a dedicated radiation angle with directivity is also produced by controlling the phase between the antenna elements.

In accordance with the invention, in the case of a first and a second antenna, the same modulation frequency is respectively applied in the simplest case, where an individual phase offset relative to the first antenna is produced in the second antenna.

This is developed by increasing the antenna elements, which increases the aperture of the arrangement and therefore increases both the directivity and the range.

It is also possible for modulation frequencies to be selected differently between the antennas. This makes it possible to subsequently implement the beamforming in a digital manner in the signal-processing part of the reading device. Such intervention in the reading device is implemented in the digital part of the device and therefore requires only a software change.

The invention is also developed if at least three antennas are arranged in a plane. This results in a three-dimensional space being able to be illuminated, where the same modulation frequency is also applied to the antennas in this embodiment in the simplest case and the antennas each have a phase offset with respect to one another.

In accordance with another embodiment, the phase offset can be set such that an adaptation can be performed. The main lobe of the antenna pattern can therefore be individually produced both in azimuth and in elevation starting from a locally defined coordinate system of the antenna array.

Like in the two-dimensional space, it is also the case here again that digital beamforming can be implemented via different modulation frequencies. In this case, a development in which the number of antennas is increased also causes an increase in the directivity and therefore the range.

This is advantageously developed if a logic and/or memory unit is added to the arrangement. In accordance with an inventive procedure, this makes it possible to store different sets of modulation frequencies, phase offsets and reflection coefficients which define different characteristics, for example, which, in accordance with the inventive methods and embodiments, are adaptively selected based on the respective environment, in particular via the logic unit, and are impressed on the antennas functionally set up in the backscatter manner. As a result, an adaptation to the respective circumstances is ensured or, irrespective of the environment, is impressed on a continuous change at stipulated, in particular very short, intervals of time. As a result, optimum reflection of the transponder is performed quasi-randomly by the antennas because it follows a stipulated selection sequence.

Information-carrying symbols and identification information can therefore also be stored in the memory and can be selected, for example, by the logic unit, for transmission via the antennas. It is likewise possible to store patterns that define whether and which antennas are individually deactivated.

In the event of an oriented backscatter array signal to the reader, the antenna arrangement in accordance with disclosed embodiments of the invention additionally functions, on account of the directivity, for a reduced power degradation on account of the multi-path propagation effect. The multi-path propagation effect impairs the system performance. As a result of the directivity, the shortest signal path to the reading device has a dominant effect in comparison with the other signal paths and can therefore be clearly interpreted by the reading device with a higher degree of probability.

In accordance with the invention, the orientation of the tag can also be captured on account of the reciprocity given in the directivity, with the result that the location and/or position of the backscatter transponder array can be measured.

Furthermore, in accordance with an embodiment of the invention, the spatial angle of the directivity (lobe, beam) can be freely selected by virtue of any desired granularity of the spatial angle and scanning being produced by individually regulating the phase offsets relative to the individual antennas and/or based on the dimensional design of the antenna arrangement, i.e., on a line (2-D) or on a plane (3-D), and/or the number of antenna elements.

In this case, the invention also comprises embodiments that can be used to implement “beam-steering” technologies.

For example, a “lock and track” technology can be implemented as a first beam-steering technology if the invention is embodied such that the tag scans the space and finds connectivity to the reading device and detects a maximum signal power for a corresponding spatial angle on the tag side or on the reading device side. If the reading device reception power is detected, then the information is forwarded to the tag and the spatial angle is therefore dynamically tracked with the aim of a best possible connection.

This requires a reader-to-tag communication infrastructure. If the reception power is detected on the tag side, equivalent spatial angle tracking is implemented with the advantage that it is possible to dispense with a reading device-to-tag communication infrastructure.

Another beam-steering technology can be implemented if the invention is embodied such that arbitrary beamforming is performed. For this purpose, all possible spatial angles are controlled with an individual pattern in a stipulated period. This results in a maximum signal power being present at the reading device at least at one time. The tag is autonomous in this case. This embodiment brings a further advantage because it can support an increased number of tags being used in the vicinity of a reading device because disjoint tags can always be randomly optimally oriented with respect to the reading device by iterating the patterns.

In the case of a system configuration having a plurality of tags, it is also possible to develop the invention such that Frequency Division Multiple Access (FDMA), Time Division Multiple Access (TDMA), Code-Division Multiple Access (CDMA), or a combination thereof makes it possible to distinguish the tags.

Another advantage of connecting and disconnecting individual antennas is also the fact that (depending on the dynamic range of the reading device used) an array gain can be varied, in particular in the case of close-range measurement, i.e., a distance in the direction of “0”, and can result in the dynamic response problem being eased.

If the current phase, i.e., the configured phase offset of the antennas, of a tag is known to the reading device, the orientation of the tag in the space relative to the reading device can also be determined. This is performed by virtue of the reading device estimating the location based on the phase information. This additional information enables further fields of application in which the position and orientation of tagged objects, for example, are intended to be adjusted.

The invention and its embodiments therefore enable a tag which, depending on the requirements, can be implemented with an overall significantly lower hardware complexity and consequently a cost-effective implementation. In this case, the hardware complexity is saved on the radar side and is moved to the transponder where it can be implemented in a manner with lower hardware complexity thanks to the invention.

In comparison with a simple directional antenna, the controllable directivity in accordance with disclosed embodiments of the invention is produced by the system in accordance with disclosed embodiments of the invention, such that a space region can be illuminated. In this case, different space regions are successively illuminated via phase control, for example. Furthermore, the diversity technologies become possible on the backscatter side. The possible overall system diversity is therefore increased considerably in comparison with the prior art. The result is, inter alia, also a greater range, an increased number of tags that can be read at most in the receiving range of the reading device, a reduced influence of multi-path propagation on the communication between the transponder and the reading device and a determination of the orientation of the tag.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The present invention is now explained in more detail on the basis of the exemplary embodiment of the invention illustrated in the figure, in which:

FIG. 1 shows an exemplary embodiment of the transponders in accordance with the invention which are operated with a conventional reader READER in accordance with one exemplary embodiment of the method in accordance with the invention; and

FIG. 2 is a flowchart of the method in accordance with the invention.

### DETAILED DESCRIPTION OF THE EXEMPLARY EMBODIMENTS

The exemplary embodiments and configurations of individual elements thereof which are described in more detail below and are partially not illustrated are preferred embodiments of the present invention. However, the invention is not restricted thereto.

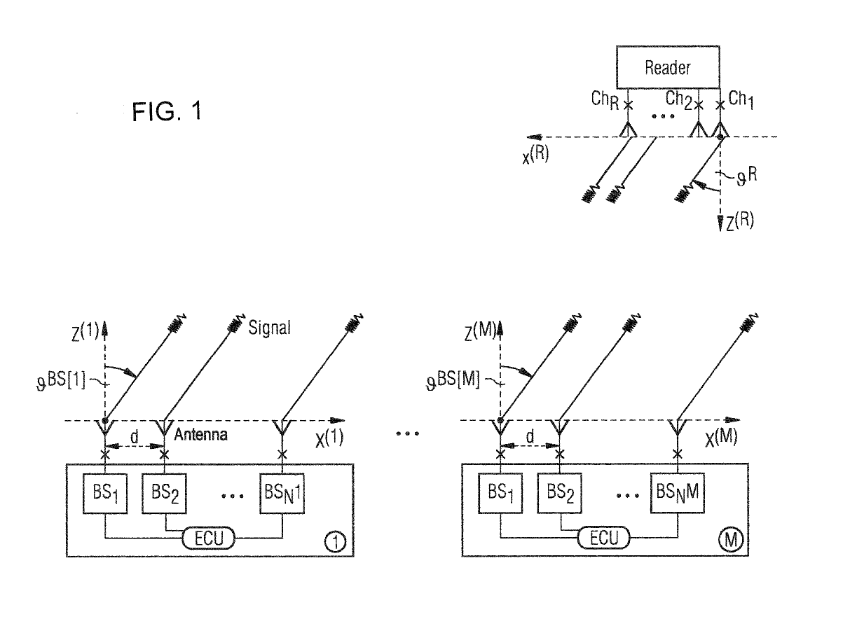

FIG. 1 shows an arrangement in which an exemplary embodiment of the transponders (tags) TAG₁ . . . TAG_{M} in accordance with the invention is illustrated, where the transponders are operated with a conventional reader READER in accordance with one exemplary embodiment of the method according to the invention.

In the illustrated arrangement, the reader READER in accordance with the prior art is available but, in order to implement this exemplary embodiment, can be configured and operated such that it can read data from tags.

It can also be capable of identifying tags and determining the distance to the tag TAG₁ . . . TAG_{M} via radar technology. It can determine the orientation of the tags TAG₁ . . . TAG_{M}. Since it has a multi-channel structure, i.e., has a number of R channels CH₁ . . . CH_{R} available, as illustrated, it can determine its angle ϑ^{R} relative to the tags TAG₁ . . . TAG_{M}.

The number of M tags TAG₁ . . . TAG_{M} indicated by three points are each configured as a backscatter array each having a number of N^{m} backscatter arrangements BS₁ . . . BS_{N}_{^{m}} each with an antenna arranged at a distance d.

Such a tag TAG₁ . . . TAG_{M} is configured such that each of the antennas can be modulated with an individual frequency f_{m,n}. The phases ϑ^{BS(m)} of the modulation for each antenna can also be detuned in accordance with the invention. This makes it possible to produce a directivity, with the result that the shortest path to the reading device becomes dominant with respect to the reading device READER in comparison with the other paths and the signal is thus received more strongly via this path than the other signals from the other paths and can be clearly interpreted by the reading device READER.

Furthermore, the overall system may have the following additional properties: the radar of the reading device has a hybrid configuration and can both determine the geometric data relating to the tag (location and orientation) and can measure the imaging background information (room reflections).

The invention is not restricted to the exemplary embodiments stated. Rather, it comprises all conceivable variations and/or combinations of individual elements thereof which are restricted only by the scope of protection of the claims.

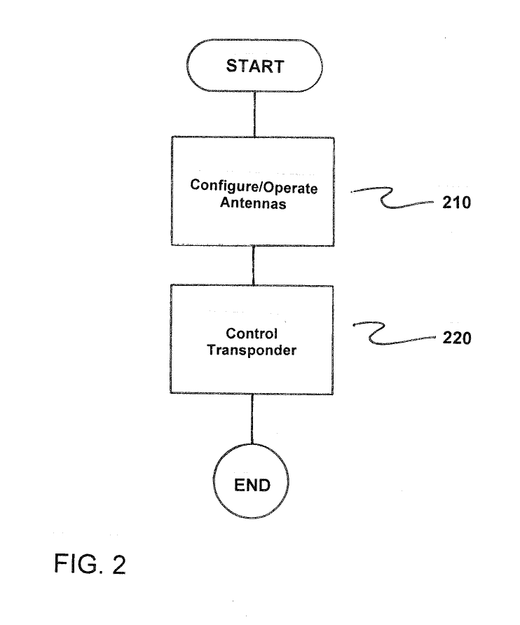

FIG. 2 is a flowchart of a method for operating a transponder in which at least one first line of at least one first and at least one second antenna is formed. The method comprises configuring and operating antennas in a backscatter manner, as indicated in step 210. Here, the antennas are functionally interconnected to one another such that, upon receiving a signal, the antennas scatter a signal back in the backscatter manner via a formed radiation characteristic.

Next, the transponder is controlled such that individual antennas are activated and/or deactivated, as indicated in step 220.

1.-13.

14. A transponder configured to form at least one first line of at least two antennas, the transponder comprising:
antennas configured and operated in a backscatter manner, said antennas being functionally interconnected to one another such that, upon receiving a signal, said antennas scatter a signal back in the backscatter manner via a formed radiation characteristic;
wherein the functional connection is configured such that individual ones of the antennas are at least one of (i) activated and (ii) deactivated.

15. The transponder as claimed in 14, wherein the antennas configured and operated in the backscatter manner scatter the signal back with the same modulation frequency in each case with a phase offset with respect to one another.

16. The transponder as claimed in 15, wherein the phase offset comprises a controllable phase offset.

17. The transponder as claimed in claim 14, wherein each of the antennas configured and operated in the backscatter manner scatter the signal back with the same phase offset with a modulation frequency with respect to one another.

18. The transponder as claimed in claim 17, wherein the modulation frequency comprises a controllable modulation frequency.

19. The transponder as claimed in claim 15, wherein each of the antennas configured and operated in the backscatter manner scatter the signal back with the same phase offset with a modulation frequency with respect to one another.

20. The transponder as claimed in claim 18, wherein the modulation frequency comprises a controllable modulation frequency.

21. The transponder as claimed in claim 17, wherein at least one third antenna functionally configured and operated in the backscatter manner is functionally and locally arranged such that a first, a second and the at least one third antennas span an area.

22. The transponder as claimed in claim 14, further comprising:
a control device connected to the antennas.

23. The transponder as claimed in claim 21, wherein the control device is implemented at least partially via logic circuits.

24. The transponder as claimed in claim 21, wherein the control device is formed as a logic circuit.

25. The transponder as claimed in claim 24, wherein the logic circuit comprises a programmable logic circuit.

26. The transponder as claimed in claim 21, wherein the control device is functionally connected to a memory device.

27. The transponder as claimed in claim 14, wherein the transponder comprises a Radio-Frequency Identification (RFID) transponder.

28. A method for operating a transponder in which at least one first line of at least one first and at least one second antenna is formed, the method comprising:
configuring and operating antennas in a backscatter manner, said antennas being functionally interconnected to one another such that, upon receiving a signal, said antennas scatter a signal back in the backscatter manner via a formed radiation characteristic; and
controlling the transponder such that individual antennas are at least one of (i) activated and (ii) deactivated.

29. The method as claimed in claim 28, wherein the antennas configured and operated in the backscatter manner, upon receiving a signal, each scatter the signal back in the backscatter manner with the same modulation frequency with a phase offset with respect to one another.

30. The method as claimed in claim 29, wherein the phase offset is a controllable phase offset.

31. The method as claimed in claim 28, wherein the antennas configured and operated in the backscatter manner, upon receiving a signal, each scatter the signal back in the backscatter manner with the same phase offset with a modulation frequency with respect to one another.

32. The method as claimed in claim 31, wherein the modulation frequency is a controllable modulation frequency.

33. The method as claimed in claim 30, wherein said control is performed such that at least one of (i) activation and (ii) deactivation is alternately performed such that a differing set of antennas is respectively actively operated for a period.

34. The method as claimed in claim 32, wherein said control is performed such that at least one of (i) activation and (ii) deactivation is alternately performed such that a differing set of antennas is respectively actively operated for a period.

35. The method as claimed in claim 33, wherein said control is performed such that sets of antennas operated by at least one of (i) the activation and (ii) deactivation are cyclically repeated.

36. The method as claimed in claim 34, wherein said control is performed such that sets of antennas operated by at least one of (i) the activation and (ii) deactivation are cyclically repeated.

37. The method as claimed in claim 28, wherein an adaptation is performed such that individual antennas are at least one of (i) activated and (ii) deactivated based on a determination of transmission power.

38. The method as claimed in claim 28, wherein the transponder is a Radio-Frequency Identification (RFID) transponder.
